(19) United States
(12) Patent Application Publication
(10) Pub. No.: US 2016/0358260 A1
(43) Pub. Date: Dec. 8, 2016

(54) ANALYZING A PERFORMANCE OF AT LEAST ONE ASSET IN A PORTFOLIO

(71) Applicant: INTECH Investment Management LLC, West Palm Beach, FL (US)

(72) Inventors: Adrian D. Banner, Princeton, NJ (US); Vasileios Papathanakos, Princeton, NJ (US); Phillip Whitman, Princeton, NJ (US)

(73) Assignee: INTECH Investment Management LLC, West Palm Beach, FL (US)

(21) Appl. No.: 14/732,304

(22) Filed: Jun. 5, 2015

(51) Int. Cl. G06Q 40/06

(52) U.S. Cl. CPC G06Q 40/06

(57) ABSTRACT

Analyzing a performance of an asset in a portfolio includes retrieving, from a number of financial sources, information for a list of trades, the list of trades representing assets associated with a portfolio that have been traded during a time interval, determining, based on the information, a number of returns associated with the list of trades over the time interval, creating, for each trade of the assets in the list of trades, a remainder fraction, the remainder fraction being equal to an initial fraction for that trade, determining, for each sale of the assets in the list of trades, a rebalancing trading profit contribution to a portfolio return over the time interval via trade attribution matching, computing an incidental exposure residual to the portfolio return over the time interval, and presenting, based on the rebalancing trading profit contribution and the incidental exposure residual, a performance of the assets in the portfolio.

### BACKGROUND

Portfolios include a collection of assets. The assets in the portfolio may be economic resources such as cash, stock, bonds, real estate, or other assets that may be traded. Further, the portfolio is designed according to investment objectives. The investment objectives may balance a risk and reward ratio of the portfolio to maximize an expected return of the portfolio and minimum risk to the expected return. Further, the portfolios may be held by individual investors or managed by financial professionals, hedge funds, banks and other financial institutions.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for analyzing a performance of at least one asset in a portfolio, according to one example of principles described herein.

FIG. 2 is a diagram of an example of a system for analyzing a performance of at least one asset in a portfolio, according to one example of principles described herein.

FIG. 3 is a diagram of an example of trade attribution matching for a number of lists of trades, according to one example of principles described herein.

FIG. 4 is a flowchart of an example of a method for analyzing a performance of at least one asset in a portfolio, according to one example of principles described herein.

FIG. 5 is a diagram of an example of an analyzing system, according to the principles described herein.

FIG. 6 is a diagram of an example of an analyzing system, according to the principles described herein.

Throughout the drawings, identical reference numbers designate similar, but not necessarily identical, elements.

### DETAILED DESCRIPTION

As noted above, a portfolio is designed according to investment strategy and objectives. The investment objectives may balance a risk and reward ratio to maximize an expected return of the portfolio and minimize risk. To determine if the portfolio is meeting the investment objectives, the assets in the portfolio are analyzed. The assets in the portfolio may be analyzed during a specific time interval to determine if the actual return of the assets in the portfolio meets or exceeds an expected or desired return.

There are several methods to determine if the actual return of the assets in the portfolio meets or exceeds the expected return. One of the methods may rely on analyzing the holdings strategy of the assets in the portfolio. However, analyzing the holdings strategy does not allow investors to determine an alternative interpretation or decomposition of the performance of the portfolio based on trading the assets. As a result, this method may not accurately determine the performance of the portfolio based on asset trading.

The principles described herein include a method for analyzing a performance of at least one asset in a portfolio. Such a method includes retrieving, from a number of financial sources, information for a list of trades, the list of trades representing assets associated with a portfolio that have been traded during a time interval, determining, based on the information, a number of returns associated with the list of trades over the time interval, creating, for each trade of the assets in the list of trades, a remainder fraction, the remainder fraction being equal to an initial fraction for that trade, determining, for each sale of the assets in the list of trades, a rebalancing trading profit contribution to a portfolio return over the time interval via trade attribution matching, computing an incidental exposure residual to the portfolio return over the time interval, and presenting, based on the rebalancing trading profit contribution and the incidental exposure residual, a performance of the assets in the portfolio. Such a method identifies a profit resulting from trading assets during a lifetime of a portfolio in a rebalancing manner by buying assets at a low cost and selling the assets at a higher cost. Further, such a method identifies an incidental exposure residual of the performance of the portfolio since the portfolio may be exposed to various risk factors.

In the present specification and in the appended claims, the term “financial sources” means a collection of systems and databases that store information associated with assets of a portfolio. The financial sources may include a financial system, a portfolio database, a return database, other systems and databases, or combinations thereof.

In the present specification and in the appended claims, the term “trade” means a process of buying or selling of an asset. The asset may be traded once or several times during a time interval.

In the present specification and in the appended claims, the term “information” means data associated with a number of assets in a list of trades. The information may include a name of an asset, when the asset was traded, returns associated with the asset, other information, or combinations thereof.

In the present specification and in the appended claims, the term “list of trades” means a number of assets in a portfolio that have been traded during a time interval. The list of trades may include one trade or several trades of the asset as characterized by a time clock. The time clock may be a buy time clock or a sell time clock.

In the present specification and in the appended claims, the term “return” means a net gain or net loss. The return may be stated in monetary terms, as a percentage, or a fraction. To determine the return, an asset, a portfolio, and/or a benchmark may be normalized and compared to a reference value. Further, there may be a number of different returns, including, but not limited to, an asset return, a portfolio return, a benchmark return, other returns, or combinations thereof.

In the present specification and in the appended claims, the term “initial fraction” means a ratio of a monetary value of a trade of an asset divided by the monetary value of the portfolio at the time of the trade such as a buy or a sell of the asset. The time of the trade may be associated with an instantaneous point in time, according to an accuracy of a clock time, at the beginning of a time interval, or at the beginning of a period associated with the interval of time. As a result, one or more trades of an asset may be consolidated into a single time. Further, the sign of the initial fraction reflects the side of the trade of the asset. If the trade of the asset is a sell, the sign of the initial fraction is negative. If the trade of the asset is a buy, the sign of the initial fraction is positive. As will be described below, the initial fraction may be stored in a financial system. A remainder fraction may be set equal to the initial fraction for a trade matching attribution process. Further, the initial fraction may remain unchanged during the trade matching attribution process.

In the present specification and in the appended claims, the term “remainder fraction” means a number used for trade attribution matching purposes. The remainder fraction may be equal to an initial fraction. The remainder fraction may be a buy remainder fraction or a sell remainder fraction depending on the sign of the remainder fraction. Further, the remainder fraction may be updated during a trade matching attribution process.

In the present specification and in the appended claims, the term “rebalancing trading profit contribution” means a monetary contribution of an asset due to trading the asset based on a trading strategy. The rebalancing trading profit contribution may be determined based on one asset, all assets in the portfolio, or any subset in-between.

In the present specification and in the appended claims, the term “incidental exposure residual” means a monetary contribution of assets in a portfolio due to exposing the portfolio to various risk factors. The incidental exposure residual may be a percentage or a monetary value.

In the present specification and in the appended claims, the term “corporate actions” means modifications made to assets by an individual and/or an organization. The corporate actions may include changing an identifier of an asset, merging an asset with another asset, demerging an asset from another asset, or subjecting the asset to a split or a reverse split.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

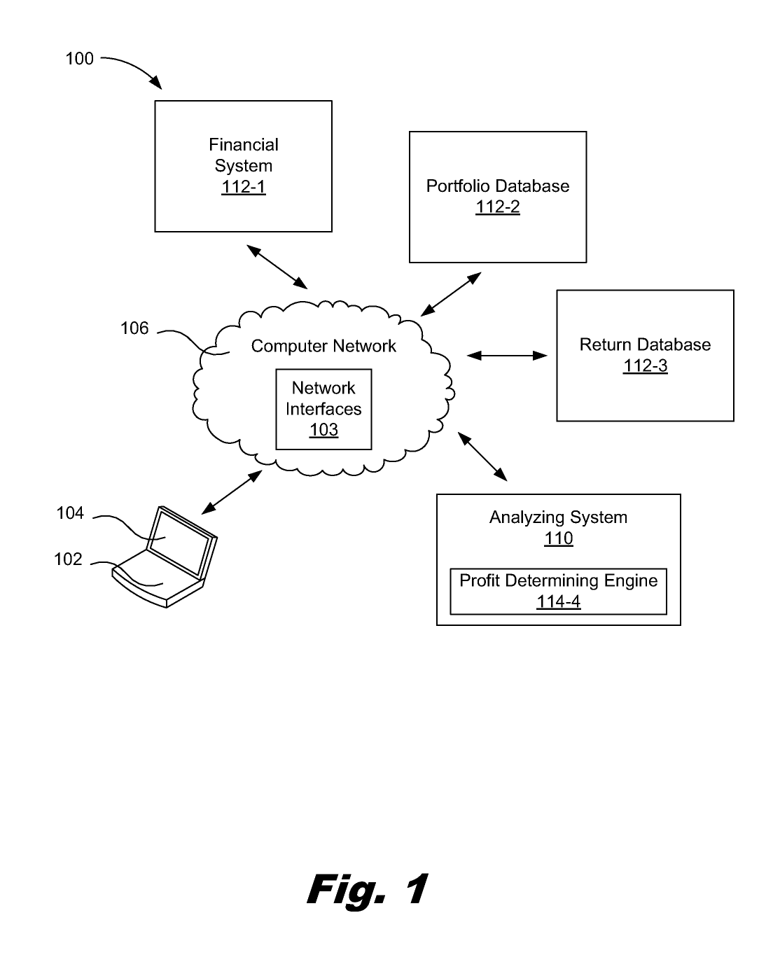

Referring now to the figures, FIG. 1 is a diagram of an example of a system for analyzing a performance of at least one asset in a portfolio, according to one example of principles described herein. As will be described further below, an analyzing system is in communication with a network to retrieve, from a number of financial sources, information for a list of trades, the list of trades representing assets associated with a portfolio that have been traded during a time interval. Further, the analyzing system determines, based on the information, a number of returns associated with the list of trades over the time interval. The analyzing system creates, for each trade of the assets in the list of trades, a remainder fraction, the remainder fraction being equal to an initial fraction for that trade. Further, the analyzing system determines, for each sale of the assets in the list of trades, a rebalancing trading profit contribution to a portfolio return over the time interval via trade attribution matching. The analyzing system computes an incidental exposure residual to the portfolio return over the time interval. Further, the analyzing system presents, based on the rebalancing trading profit contribution and the incidental exposure residual, a performance of the assets in the portfolio.

As illustrated, the system (100) includes a number of financial sources (112). The financial sources (112) may gather and store information, such as a list of trades, for a number of assets in a portfolio. The list of trades may include assets associated with a portfolio that have been traded during a time interval. For example, the financial system (112-1) may trade the assets in the portfolio according to a trading strategy. As a result, the financial system (112-1) may store information such as when an asset was bought or sold according to a timestamp or clock time.

The financial sources (112) may further include a portfolio database (112-2). The portfolio database (112-2) may gather and store information such as the total value of the portfolio. The total value of the portfolio may be stated in monetary terms.

Further, the financial sources (112) may include a return database (112-3). The return database (112-3) may store a number of returns for each of the assets in the portfolio. The number of returns may include an asset return, a portfolio return, and a benchmark return.

Further, the system (100) includes a display device (102) with a display (104). As will be described in other parts of this specification, a performance of the assets in the portfolio may be presented via the display (104). More information about presenting the performance will be described in other parts of this specification.

The system (100) further includes a computer network (106). The computer network (106) may be a telecommunications network that allows systems, computers, and servers to exchange data. For example, the computer network (106) may allow the financial system (112-1), the portfolio database (112-2), the return database (112-3), an analyzing system (110), and the display device (102) to exchange data.

To allow the computers and the servers to exchange data, the computer network (106) may include various hardware components. The hardware components may include processors, a number of data storage devices, a number of peripheral device adapters, and a number of network interfaces (103). The various hardware components may be connected to each other by buses and network connections. Further, the various hardware components may be physically located on the computer network (106). Alternatively, the various hardware components may be physically located in other locations. The other locations may include the financial system (112-1), the portfolio database (112-2), the return database (112-3), the analyzing system (110), the display device (102), or combinations thereof.

As mentioned above, the computer network (106) includes the network interfaces (103). The network interfaces (103) may be used for communicating data via the computer network (106). The network interfaces (103) may connect the financial system (112-1), the portfolio database (112-2), the return database (112-3), the analyzing system (110), and the display device (102) to the computer network (106). As a result, data may be exchanged between the financial system (112-1), the portfolio database (112-2), the return database (112-3), an analyzing system (110), and the display device (102) via the network interfaces (103) of the computer network (106).

In some examples, the data generated by the financial system (112-1), the portfolio database (112-2), and the return database (112-3) may be voluminous. For example, the financial system (112-1) may store, in memory, thousands of trades associated with thousands of assets for a number of portfolios. Each time a trade of an asset is made, data associated with that trade is stored in the financial system (112-1). As a result, data associated with the financial system (112) is constantly changing. Further, the portfolio database (112-2) may store, in memory, values, stated in monetary terms, for a number of portfolios. Each time a trade of an asset is made, the values of the portfolios change. As a result, data associated with the portfolio database (112-2) is constantly changing. Similarly, the return database (112-3) may store, in memory, returns associated with thousands of assets for a number of portfolios. Each time a trade of an asset is made, the data associated with the returns are updated and stored in the return database (112-3). As a result, data associated with the return database (112-3) is constantly changing. Because the data in the financial system (112-1), the portfolio database (112-2), and the return database (112-3) is voluminous and constantly changing, the computer network (106) is best suited for handling such data exchanges between the financial system (112-1), the portfolio database (112-2), the return database (112-3), and the analyzing system (110). As a result, the analyzing system (110) may perform its functions properly and timely.

The system (100) further includes the analyzing system (110). The analyzing system (110) may be in communication with the display device (102), the financial system (112-1), the portfolio database (112-2), and the return database (112-3) over the computer network (106).

The analyzing system (110) retrieves, from a number of financial sources (112), information for a list of trades, the list of trades representing assets associated with a portfolio that have been traded during a time interval. As will be described below, each of the assets in the portfolio are characterized by a time clock, a side of each trade, and an initial fraction.

The analyzing system (110) determines, based on the information, a number of returns associated with the list of trades over the time interval. As mentioned above the number of returns includes the asset return, the portfolio return, and the benchmark return.

Further, the analyzing system (110) creates, for each trade of the assets in the list of trades, a remainder fraction, the remainder fraction being equal to an initial fraction for that trade. The initial fraction may be a ratio of a monetary value of the trade divided by the monetary value of the portfolio at the time of the trade. Further, the sign of the initial fraction reflects the side of the trade.

A profit determining engine (114-4) of the analyzing system (110) determines, for each sale of the assets in the list of trades, a rebalancing trading profit contribution to a portfolio return over the time interval via trade attribution matching. More information about trade attribution matching will be described in other parts of this specification.

Further, the analyzing system (110) computes an incidental exposure residual to the portfolio return over the time interval. More information about incidental exposure residual will be described in other parts of this specification.

The analyzing system (110) further presents, based on the rebalancing trading profit contribution and the incidental exposure residual, a performance of the assets in the portfolio. The analyzing system (110) may present the performance of the assets in the portfolio via the display (104) of the display device (102). Such a system identifies a profit resulting from trading assets during a lifetime of a portfolio in a rebalancing manner by buying assets at a low cost and selling the assets at a higher cost. Further, such a system identifies an incidental exposure residual of the performance of the portfolio when the portfolio is exposed to various risk factors. More information about the analyzing system (110) will be described later on in this specification.

While this example has been described with reference to the analyzing system being located over the network, the analyzing system may be located in any appropriate location according to the principles described herein. For example, the analyzing system may be located in a user device, a display device, a server, a datacenter, financial sources, other locations, or combinations thereof.

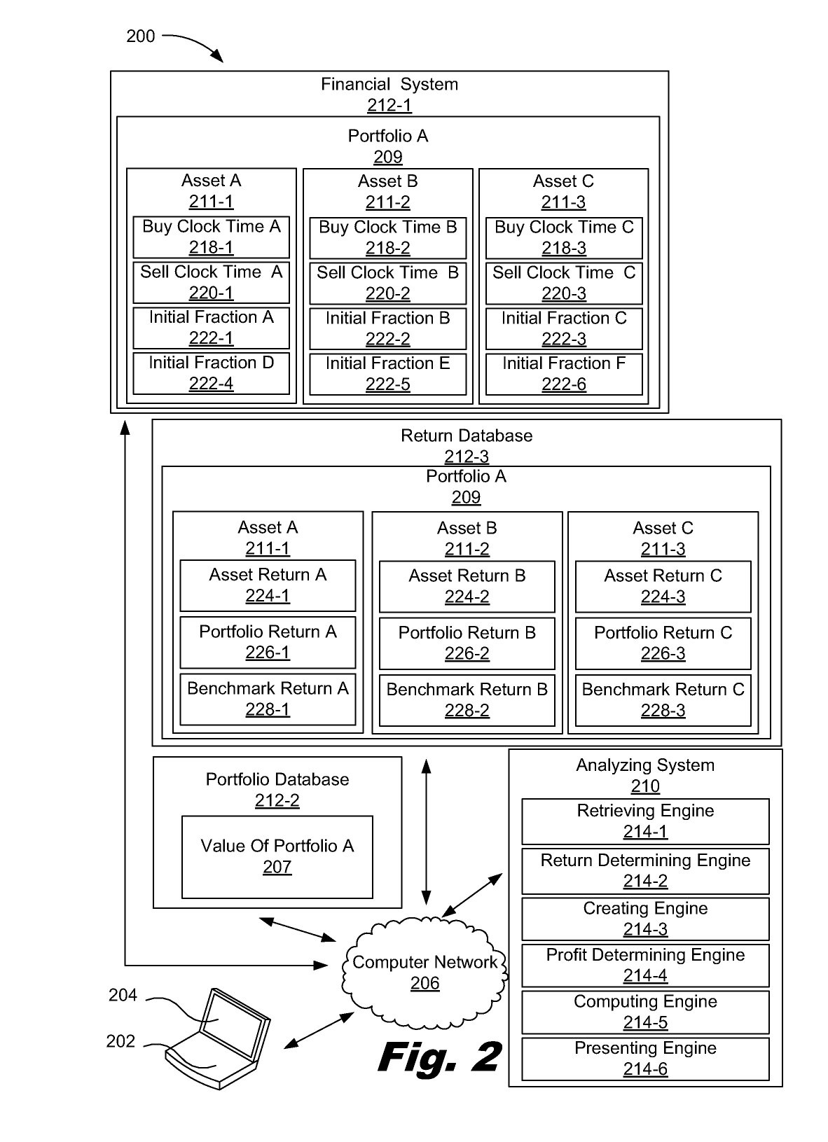

FIG. 2 is a diagram of an example of a system for analyzing a performance of at least one asset in a portfolio, according to one example of principles described herein. As will be described below, an analyzing system may be in communication with a network to analyze a performance of a portfolio of assets relative to a performance of a benchmark portfolio over time. The analyzing system identifies two performance components. The first component corresponds to the profit resulting from trading securities during the lifetime of the portfolio in a rebalancing manner. The second component corresponds to the residual of the performance, which is due to incidental exposures of the portfolio to various risk factors. Further, the analyzing system allows the computation of the trading profit on an individual basis for individual assets and individual instants in time, as well as an aggregate basis for a group of assets such as the entire portfolio. In addition, the analyzing system allows for treatment of realistic considerations such as corporate actions, an inception trade to an initial portfolio configuration, and intervening trades necessitated by cash-flow, rather than investment, and other considerations.

As illustrated, the system (200) includes a number of financial sources (212). The financial sources (212) include a financial system (212-1). Although the financial system (212-1) is illustrated as a single system, the financial system (212-1) may include a collection of systems. The financial system (212-1) may trade the assets (211) in portfolio A (209) according to a trading strategy. As a result, the financial system (212-1) may store information such as when an asset was bought or sold according to a time clock.

As illustrated, the financial system (212-1) may include portfolio A (209). Portfolio A (209) may be an aggressive portfolio. An aggressive portfolio may include assets that are high risk and high reward in terms of returns. As a result, the assets may have a high beta. Portfolio A (209) may be a defensive portfolio. A defensive portfolio may include assets that are fairly isolated from broad market movements. As a result, the beta for the assets may be low. Portfolio A (209) may be an income portfolio. The income portfolio focuses on making money through dividends or other types of distributions to stakeholders. Portfolio A (209) may be a hybrid portfolio. The hybrid portfolio may venture in bonds, commodities, and real estate. Further, portfolio A (209) may be a diversified portfolio that include a number of assets (211-1).

Further, the financial system (212-1) may gather and store information for a list of trades. The list of trades may include assets (211) associated with portfolio A (209) that have been traded during a time interval. In an example, the time interval may be split up into a number of periods. The periods may include a first period, a second period, a third period, a fourth period, a fifth period, a sixth period, a seventh period, an eighth period, a ninth period, and a tenth period. More information about the periods will be described later on in this specification.

Regardless of the type of portfolio A (209) is, portfolio A (209) includes a number of assets (211). As illustrated, the assets (211) include asset A (211-1), asset B (211-2), and asset C (211-3). Further, each of the assets (211) may be bought and sold as characterized by a clock time such as a buy time clock (218) or a sell time clock (220).

As illustrated, asset A (211-1) includes buy clock time A (218-1). Buy clock time A (218-1) may indicate when portions of asset A (211-1) were bought. In an example, buy clock time A (218-1) indicates asset A (211-1) was bought during a first period, a second period, and a fourth period of a time interval.

Further, asset A (211-1) includes sell clock time A (220-1). Sell clock time A (220-1) may indicate when portions of asset A (211-1) were sold. In an example, sell clock time A (220-1) indicates asset A (211-1) was sold during a fifth period and a ninth period of the time interval.

Further, asset A (211-1) may include initial fraction A (222-1). Initial fraction A (222-1) may be a ratio of a monetary value of the trade divided by the monetary value of portfolio A (209) at the time a buy, as indicated by the buy clock time A (218-1), of asset A (211-1) was made. Further, the sign of initial fraction A (222-1) reflects the side of the trade. Since the trade is a buy, the sign of initial fraction A (222-1) is positive. Asset A (211-1) may further include initial fraction D (222-4). Initial fraction D (222-4) may be a ratio of a monetary value of the trade divided by the monetary value of portfolio A (209) at the time a sell, as indicated by the sell clock time A (220-1), of asset A (211-1) was made. Further, the sign of initial fraction D (222-4) reflects the side of the trade. Since the trade is a sell, the sign of initial fraction D (222-4) is negative.

Similarly, asset B (211-2) includes buy clock time B (218-2). Buy clock time B (218-2) may indicate when portions of asset B (211-2) were bought. In an example, buy clock time B (218-2) indicates asset B (211-2) was bought during a first period, a third period, and a fourth period of a time interval.

Further, asset B (211-2) includes sell clock time B (220-2). Sell clock time B (220-2) may indicate when portions of asset B (211-2) were sold. In an example, sell clock time B (220-2) indicates asset B (211-1) was sold during a fifth period of the time interval.

Further, asset B (211-2) may include initial fraction B (222-2). Initial fraction B (222-2) may be a ratio of a monetary value of the trade divided by the monetary value of portfolio A (209) at the time a buy, as indicated by the buy clock time B (218-2), of asset B (211-2) was made. Further, the sign of initial fraction B (222-2) reflects the side of the trade. Since the trade is a buy, the sign of initial fraction B (222-2) is positive. Asset B (211-2) may further include initial fraction E (222-5). Initial fraction E (222-5) may be a ratio of a monetary value of the trade divided by the monetary value of portfolio A (209) at the time a sell, as indicated by the sell clock time B (220-2), of asset B (211-2) was made. Further, the sign of initial fraction E (222-5) reflects the side of the trade. Since the trade is a sell, the sign of initial fraction E (222-5) is negative.

Similarly, asset C (211-3) includes buy clock time C (218-3). Buy clock time C (218-3) may indicate when portions of asset C (211-3) were bought. In an example, buy clock time C (218-3) indicates asset C (211-3) was bought during a first period, a second period, and a third period of a time interval.

Further, asset C (211-3) includes sell clock time C (220-3). Sell clock time C (220-3) may indicate when portions of asset C (211-3) were sold. In an example, sell clock time C (220-3) indicates asset C (211-3) was sold during a tenth period of the time interval.

Further, asset C (211-3) may include initial fraction C (222-3). Initial fraction C (222-3) may be a ratio of a monetary value of the trade divided by the monetary value of portfolio A (209) at the time a buy, as indicated by the buy clock time C (218-3), of asset C (211-3) was made. Further, the sign of initial fraction C (222-3) reflects the side of the trade. Since, the trade is a buy, the sign of initial fraction C (222-3) is positive. Asset C (211-3) may further include initial fraction F (222-6). Initial fraction F (222-6) may be a ratio of a monetary value of the trade divided by the monetary value of portfolio A (209) at the time a sell, as indicated by the sell clock time C (220-3), of asset C (211-3) was made. Further, the sign of initial fraction F (222-6) reflects the side of the trade. Since the trade is a sell, the sign of initial fraction F (222-6) is negative. As a result, the financial system (212-1) may store information such as when an asset was bought or sold according to a time clock.

As illustrated, the system (200) includes a portfolio database (212-2). The portfolio database (212-2) may gather and store information such as the total value of a portfolio A (209). The total value of portfolio A (209) may be in monetary terms. As illustrated, the portfolio database (212-2) may store the value of portfolio A (207). As a result, initial fraction A (222-1), initial fraction B (222-2), and initial fraction C (222-3) may be determined as described above.

As illustrated, the system (200) includes a return database (212-3). Although the return database (212-3) is illustrated as a single database, the return database (212-3) may include a collection of databases. The return database (212-3) may store a number of returns (224, 226, 228) for each of the assets (211) in portfolio A (209). As illustrated, asset A (211-1) may include asset return A (224-1), portfolio return A (226-1), and benchmark return A (228-1). Asset B (211-2) may include asset return B (224-2), portfolio return B (226-2), and benchmark return B (228-2). Further, asset C (211-3) may include asset return C (224-3), portfolio return C (226-3), and benchmark return C (228-3).

Further, the system (200) includes a display device (202) with a display (204). A performance of the assets in the portfolio may be presented via the display (204). More information about presenting the performance of the assets in the portfolio will be described in other parts of this specification.

The system (200) further includes an analyzing system (210). In one example, the analyzing system (210) includes a processor and computer program code. The computer program code is communicatively coupled to the processor. The computer program code includes a number of engines (214). The engines (214) refer to program instructions for performing a designated function. The computer program code causes the processor to execute the designated function of the engines (214). In other examples, the engines (214) refer to a combination of hardware and program instructions to perform a designated function. Each of the engines (214) may include a processor and memory. The program instructions are stored in the memory and cause the processor to execute the designated function of the engine. As illustrated, the analyzing system (210) includes a retrieving engine (214-1), a return determining engine (214-2), a creating engine (214-3), a profit determining engine (214-4), a computing engine (214-5), and a presenting engine (214-6).

The retrieving engine (214-1) retrieves, from the number of financial sources, information for a list of trades, the list of trades representing assets associated with a portfolio that have been traded during a time interval. For example, the retrieving engine (214-1) retrieves from the financial system (212-1), the return database (212-3), and the portfolio database (212-2), information for asset A (211-1), asset B (211-2), and asset C (212-3) of portfolio A (209). As mentioned above, each of the assets (212) in portfolio A (209) are characterized by the time clock (218, 220), a side of each trade, and an initial fraction (222).

In some examples, multiple trades of an asset may be made at the same time. As a result, an aggregate trade of the assets replaces a trade of the assets when more than one trade of the assets occurs within an accuracy of the time clock. For example, if more than one trade occurs at the same time, within the accuracy of the time clock, then they are replaced with an aggregate trade that has a net initial fraction of the collection of trades and the side of the trade is determined by the sign of the net initial fraction.

Further, the assets (211) may be modified by corporate actions. The corporate actions may include changing an identifier of at least one of the assets. For example, if an asset changes identifiers such as CRP to CYY, then the lists of trades of the asset prior and subsequent to the change are combined to a single list of trades. This treatment is repeated as many times as the number of changes of identifiers.

Corporate actions include creating a split or a reverse split of at least one of the assets. If an asset experiences a split or reverse split, then the lists of trades are unaffected, as the characteristics of each trade are not price-dependent, and no adjustment is needed.

Further, corporate actions include a demerging of at least one of the assets. If an asset spins off another asset or a demerger event occurs, then each of the offspring is allocated a copy of the list of trades prior to the event. For each of the offspring, the initial fraction of each trade may be allocated in proportion to the benchmark weight if available, or capitalization or proper equivalent measure for non-equities weight if the benchmark weight is not available, at the time of the event. Because all assets are not linked to capitalization, the proper equivalent measure for non-equities weight may include a weight by value.

Corporate actions include a merging of at least one of the assets. For example, if multiple assets merge, then the combined asset is treated as a collection of the assets present prior to the event. Each trade subsequent to the event is allocated in proportion to the benchmark weight if available, or capitalization or proper equivalent measure for non-equities weight if the benchmark weight is not available at the time of the event.

In some examples, the assets of the portfolio created at a discrete instant in time may be pretreated. For example, if a portfolio is established at a discrete instant in time, then the corresponding trades from cash or in kind positions to the initial holding weight of the portfolio are pretreated by replacing a trade from the benchmark weight if available, or capitalization or proper equivalent measure for non-equities weight if the benchmark weight is not available to the initial holding weight of the portfolio. Further, if the benchmark weight is not available the trade may be set to zero.

In an example, a collection of the assets may be further pretreated when the collection of the assets is implemented at a specific clock time for the purposes of inserting or extracting cash liquidity to or from the portfolio. For example, if a collection of trades are implemented on a particular clock time for the purposes of inserting or extracting cash liquidity to or from the portfolio, then they are pretreated. They are pretreated by using the computed total dollar values for the buys and sells respectively for the clock time. For the selling of an asset, the dollar value is taken to have a negative sign. Further, the portfolio dollar value at the clock time is computed. The fractional net cash flow trade is computed. The fractional net cash flow trade may be defined as follows in formula 1:

N(C)=(D(C,B)−D(C,S))/P(C) (Formula 1)

Where N(C) is the fractional net cash flow trade, D(C,B) is the total dollar value for the buys at a clock time C, D(C,S) is the total dollar value for the sells at a clock time C, and P(C) is the portfolio dollar value. Further, all of the trades in the same side as the net cash flow trade are adjusted by subtracting the product of the portfolio weight times the proportionality factor such as the fractional net cash flow trade. For example, if the cash flow was an injection of capital equal to five percent of the portfolio value, adjust all of the buys by subtracting 0.05 times the portfolio shares. Further, any of the trades on the opposite side of the net cash flow trade are not adjusted.

The return determining engine (214-2) determines, based on the information, a number of returns associated with the list of trades over the time interval. Returns may denote the total arithmetic return of an asset over a time interval. For example, if the price of the asset was P1 and P2 at the two clock times C1 and C2 respectively, and the asset experienced a total dividend or coupon payment of D over the same interval, then the return is defined via the formula 2:

R=(P₂+D)/P₁−1 (Formula 2)

For each pair, such as a buy and a subsequent sale of the same asset, the return determining engine (214-2) determines a time interval. For a subset of all such pairs, which will be specified further below, it is needed to determine the three returns.

As mentioned above, one of the three returns associated with the list of trades over the time interval includes an asset return. Further, the return asset may be a return of the asset over a time interval. As a result, the return asset may be defined as R_{A}(I(B,S)) where R_{A} is the return asset and I(B,S) is the time interval when the asset was bought then sold.

As mentioned above, one of the three returns associated with the list of trades over the time interval includes a portfolio return. Further, the portfolio return may be a return of the portfolio over a time interval. As a result, the portfolio return may be defined as R_{A}(I(B,S)) where R_{P} is the return of the portfolio and I(B,S) is the time interval when the asset was bought then sold.

Further, one of the three returns associated with the list of trades over the time interval includes a benchmark return. Further, the benchmark return may be a return of the benchmark over a time interval. As a result, the benchmark return may be defined as R_{O}(I(B,S)) where R_{O} is the return of the benchmark and I(B,S) is the time interval when the asset was bought then sold. As a result, the return determining engine (214-2) determines these three returns as asset returns (224), the portfolio returns (226), and the benchmark returns (228) for each asset (211) respectively.

The creating engine (214-3) creates, for each trade of the assets in the list of trades, a remainder fraction, the remainder fraction being equal to an initial fraction for that trade. For purposes of explication the remainder fraction may be defined as Fᵣₑₘ. For example, Fᵣₑₘ for asset A (211-1) may be equal to initial fraction A (222-1). The Fᵣₑₘ may be a sell remainder fraction, Fᵣₑₘ(S), or a buy remainder fraction, Fᵣₑₘ(B).

The profit determining engine (214-4) determines, for each sale of the assets in the list of trades, a rebalancing trading profit contribution to a portfolio return over the time interval via trade attribution matching. The profit determining engine (214-4) determines, for each sale of the assets in the list of trades, the rebalancing trading profit contribution to the portfolio return over the time interval via the trade attribution matching by ordering each sale of the assets in the list of trades sequentially based on a clock time. For example, for each of the sales in the list of trades the profit determining engine (214-4) sequentially orders each of the sales according to an advancing clock time. For example, sell clock time A (220-1) includes sell time one, sell time two, and sell time three. Sell time one, sell time two, and sell time three are sequentially ordered to the advancing clock time.

The profit determining engine (214-4) determines if a sell remainder fraction for one of the assets is zero. For example, if the sell remainder fraction is zero, the profit determining engine (214-4) moves to the next sell in the list of trades. Else the profit determining engine (214-4) calculates the equations below and the sell remainder fraction is reanalyzed. If no more sells remain, the profit determining engine (214-4) moves to the next asset and establishes the remainder fraction for a new trade to be equal to the initial fraction for that trade. As will be described below, the buy remainder fraction and sell remainder fraction may be updated according to equation 4 and equation 5. As a result, the profit determining engine (214-4) may use the updated buy remainder fraction and sell remainder fraction to re-determine if the above conditions are met. Further, the buy remainder fraction and sell remainder fraction are updated until the above conditions are met. More information about updating the remainder fraction will be described below.

The profit determining engine (214-4) further identifies a buy of one of the assets with a buy clock time prior to a sell clock time for which a buy remainder fraction is positive. For example, the profit determining engine (214-4) identifies the buy of the trade with the most recent buy clock time prior to a sell clock time for which the buy remainder fraction is positive.

Further, the profit determining engine (214-4) computes a discount factor. The discount factor may be defined by equation 1:

D(B,S)=G+R_{A}(I(B,S))/(1+R_{P}(I(B,S)) (Equation 1)

Where D(B,S) is the discount factor, R_{A}(I(B,S) is the return asset, R_{P} is the portfolio return and I(B,S) is the time interval when the asset was bought then sold.

The profit determining engine (214-4) further computes a buy discount remainder fraction of a portfolio weight bought discounted at the sell clock time. The buy discount remainder fraction may be defined by equation 2:

F_{rem,dsc}(B)=Fᵣₑₘ(B)*D(B,S) (Equation 2)

Where F_{rem,dsc}(B) is the buy discount remainder fraction, Fᵣₑₘ(B) is the buy remainder fraction and D(B,S) is the discount factor.

Further, the profit determining engine (214-4) computes a matched weight. The matched weight may be a portion of the asset at a sell clock time that can be matched to a previous buy clock time. Further, the weight of the asset is adjusted by the asset return over the portfolio return during the period. The matched weight may be defined by equation 3:

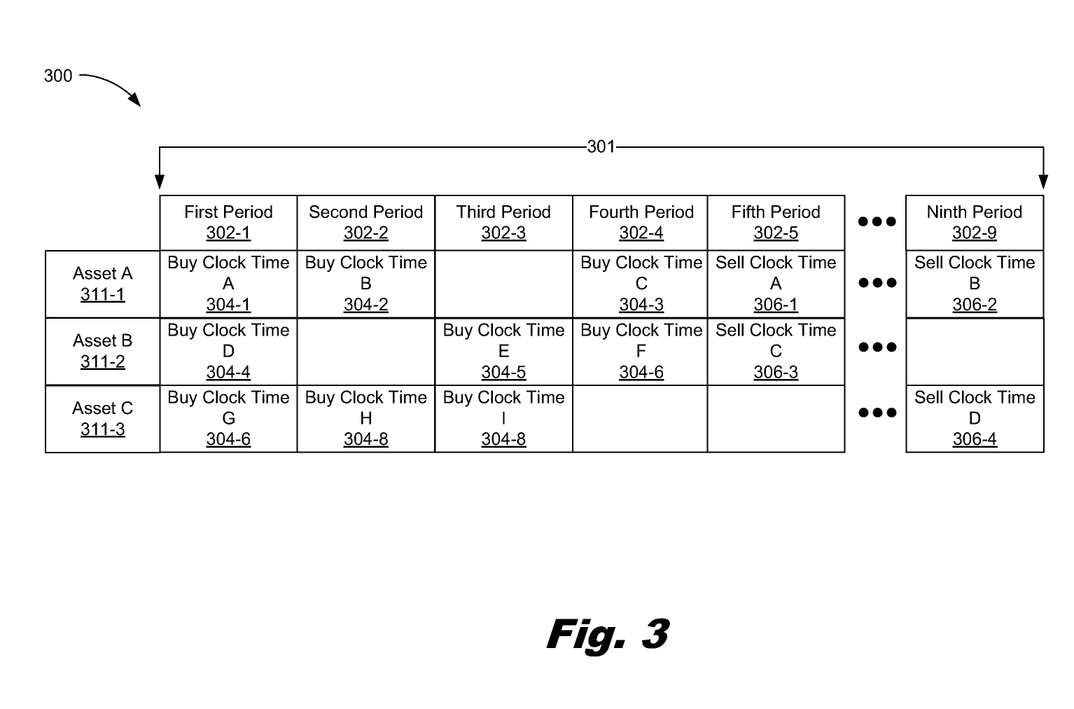

M(B,S)=min(−Fᵣₑₘ(S),F_{rem,dsc}(B)) (Equation 3)

Where M(B,S) is the matched weight, min is a minimum function, Fᵣₑₘ(S) is the sell remainder fraction, and F_{rem,dsc}(B) is the buy discount remainder fraction. If Fᵣₑₘ(S) is greater than F_{rem,dsc}(B), there are remaining sells of the asset that need to be matched and there are no buys of the asset remaining. If Fᵣₑₘ(S) is less than F_{rem,dsc}(B) the sale of the asset is fully matched. However, the buys of the asset remain. If Fᵣₑₘ(S) and F_{rem,dsc}(B) are equal, the sale of the asset is fully matched and the buy of the asset does not remain. In some examples, the matched weight is expressed as a percentage. As a result, the matched weight is the minimum of the sell remainder fraction or the buy discount remainder fraction. More information about matching the sales and the buys of the asset will be described in FIG. 3.

The profit determining engine (214-4) further reduces the buy remainder faction by a quantity of the matched weight divided by the discount factor as defined in equation 4:

Fᵣₑₘ(B)=Fᵣₑₘ(B)−M(B,S)/D(B,S) (Equation 4)

Where the Fᵣₑₘ(B) on the right-hand side of equation 4 is the buy remainder faction that was established as described in the paragraphs above. The Fᵣₑₘ(B) on the left-hand side of equation 4 is an updated version of the buy remainder faction as defined by equation 4. Further, the Fᵣₑₘ(B) on the left-hand side of equation 4 is used in the subsequent equations below. As mentioned above, the profit determining engine (214-4) may use the Fᵣₑₘ(B) on the left-hand side of equation 4 to re-determine if the above conditions are met. As a result, the Fᵣₑₘ(B) may be updated to a new value via equation 4 until the conditions described above are met.

Further, the profit determining engine (214-4) reduces the sell remainder fraction by the matched weight as defined in equation 5:

Fᵣₑₘ(S)=Fᵣₑₘ(S)−M(B,S) (Equation 5)

Where the Fᵣₑₘ(S) on the right-hand side of equation 5 is the sell remainder faction that was established as described in the paragraphs above. The Fᵣₑₘ(S) on the left-hand side of equation 5 is an updated version of the sell remainder faction as defined by equation 5. Further, the Fᵣₑₘ(S) on the left-hand side of equation 5 is used in the subsequent equations below. As mentioned above, the profit determining engine (214-4) may use the Fᵣₑₘ(S) on the left-hand side of equation 5 to re-determine if the above conditions are met. As a result, the Fᵣₑₘ(S) may be updated to a new value via equation 5 until the conditions described above are met.

The profit determining engine (214-4) further computes a relative return difference. The relative return difference is defined in equation 6:

R_{R}(B,S)=log((1+R_{A}(I(B,S)))/(1+R_{O}(I(B,S)))) (Equation 6)

Where R_{R}(B,S) is the relative return difference, R_{A}(I(B,S) is the asset return, and R_{O}(I(B,S) is the benchmark return.

Further, the profit determining engine (214-4) computes a contribution of a trade profit due to a trading of the assets. For example, the profit determining engine (214-4) computes the contribution of the trading profit due the trades of the assets via equation 7:

R_{T}(B,S)=C*M(B,S)*R_{R}(B,S) (Equation 7)

Where R_{T}(B,S) is the contribution of the trading profit and C is a multiplying constant. Further, weights are used as opposed to number of shares for an asset to neutralize the impact of corporate actions and portfolio cash flows. Further, the multiplying constant may be a numeric value that is based on a number of factors. The number of factors includes the portfolio that is being analyzed, the type of asset, market volatility, other factors, or combinations thereof. In an example, the multiplying constant may be 0.5. The multiplying constant of 0.5 may be needed to derive the contribution of the trading profit for realistic values of volatility in equity markets. The determination of the appropriateness of the value for the multiplying constant is based on the analysis of the performance of a variety of simulated and live equity strategies, including equal weighted portfolio relative to a cap weighted index, and a rebalanced versus buy and hold of two asset examples using a family of statistical models. In other examples, the multiplying constant may be 1 depending on the factors. In still other examples, the multiplying constant may be 0.6 depending on the factors.

The profit determining engine (214-4) further accumulates, based on the sell clock time, the contribution of the trade profit to an overall sum, the overall sum representing the rebalancing trading profit contribution to the portfolio return over the time interval. For example, if the sell clock time for the sale of an asset lies in the time interval, R_{T}(B,S) is accumulated to an overall sum R_{T}(I). The result accumulated in R_{T}(I) is the rebalancing trading profit contribution to the portfolio return R_{P}(I) over the time interval.

The profit determining engine (214-4) may repeat its operation based on the conditions described above. The operation of the profit determining engine (214-4) may repeat until there are no more trades of the asset to analyze.

The computing engine (214-5) computes an incidental exposure residual to the portfolio return over the time interval. The incidental exposure residual to the portfolio return over the interval I may be computed via equation 8:

R_{I}(I)=R_{P}(I)−R_{T}(I) (Equation 8)

Where R_{I}(I) is the incidental exposure residual, R_{P}(I) if the portfolio return over the time interval, and R_{T}(I) is the rebalancing trading profit contribution over the time interval.

The presenting engine (214-6) presents, based on the rebalancing trading profit contribution and the incidental exposure residual, a performance of the assets in the portfolio. The performance of the assets in the portfolio may be presented via the display (204) of the display device (202). For example, the presenting engine (214-6) presents a performance of asset A (211-1), asset B (211-2), and asset C (211-3) of portfolio A (209) via the display (204) of the display device (202).

The performance of the assets (211) in portfolio A (209) may be presented based on sectors. Sectors may include an energy sector, a financial sector, a healthcare sector, an industry sector, an information technology sector, a material sector, a telecommunications services sector, a utilities sector, other sectors or combinations thereof. Further, the performance of the assets (211) in portfolio A (209) may be presented based on country, a time interval, a top number of contributors or detractors. The performance of the assets (211) in portfolio A (209) may be further presented based on, but not limited to, market rank, trading cost, foreign ownership limit, style score such as growth, value, or defensive, and fundamental characteristics such as earning per share (EPS) and yield.

Further, the performance of the assets (211) in portfolio A (209) may be presented as a bar graph. The bar graph may visually illustrate the incidental exposure residual and the rebalancing trading profit contribution. Further, the bar graph may compare the incidental exposure residual and the rebalancing trading profit contribution across a number of markets. Further, the performance of the assets (211) in portfolio A (209) may be presented as a pie chart, a histogram, a dot plot, a scatterplot, other types of graphs, or combinations thereof.

An overall example of FIG. 2 will now be described. The retrieving engine (214-1) retrieves, from a number of financial sources, information for a list of trades, the list of trades representing assets associated with a portfolio that have been traded during a time interval. The retrieving engine (214-1) retrieves information for asset A (211-1), asset B (211-2), and asset C (211-3) of portfolio A (209) as described above. The return determining engine (214-2) determines, based on the information, a number of returns associated with the list of trades over the time interval. The returns may be determined as described above for asset A (211-1), asset B (211-2), and asset C (211-3) of portfolio A (209). The creating engine (214-3) creates, for each trade of the assets in the list of trades, a remainder fraction, the remainder fraction being equal to an initial fraction for that trade as described above. The profit determining engine (214-4) determines, for each sale of the assets in the list of trades, a rebalancing trading profit contribution to a portfolio return over the time interval via trade attribution matching as described above. The computing engine (214-5) computes an incidental exposure residual to the portfolio return over the time interval as described above. The presenting engine (214-6) presents, based on the rebalancing trading profit contribution and the incidental exposure residual, a performance of the assets in the portfolio. The presenting engine (214-6) presents the rebalancing trading profit contribution and the incidental exposure residual for asset A (211-1), asset B (211-2), and asset C (211-3) of portfolio A (209) as a bar graph.

FIG. 3 is a diagram of an example of trade attribution matching for a number of lists of trades, according to one example of principles described herein. As will be described below, sells of an asset are matched with previous buys of the asset to capture rebalancing trading profit contributions. The trade attribution matching is implemented through a last-in, first-out (LIFO) method. If a sale of the asset is not fully matched to a previous buy for that asset, then the remaining sell for that asset is matched to another previous buy for that asset. At every step remaining buys of that asset are calculated by deducting the matching sells of the asset.

As illustrated, the diagram (300) includes a time interval (301). The time interval (301) may be divided into a number of periods (302). The periods (302) include a first period (302-1), a second period (302-2), a third period (302-2), a fourth period (302-4), a fifth period (302-5), and a ninth period (302-9). The periods (302) correspond to a specific time during the time interval (301) that an asset was traded. The specific time may be in terms of terms of seconds, minutes, hours, days, weeks, months, years, or combinations thereof. For example, the first period (302-1) may be a specific date such as Jan. 4, 2015. The first period (302-1) may specify, via the buy clock times associated with the first period (302-1), asset A (311-1), asset B (311-2), and asset C (311-3) were bought on Jan. 4, 2015. Further, the fifth period (302-5) may be a specific date such as Mar. 19, 2015. The fifth period (302-5) may specify, via sell clock times associated with the fifth period (302-5), asset A (311-1) and asset B (311-2) were sold on Mar. 19, 2015. As a result, the periods (302) represent an instant in time when assets are traded.

Further, the diagram (300) includes a number of assets (311-1). The assets (311) include asset A (311-1), asset B (311-2), and asset C (311-3). As described in FIG. 2 the assets may be bought and sold as characterized by buy time clocks (304) and sell time clocks (306). For example, buy time clock A (304-1) indicates a portion of asset A (311-1) was bought during the first period (302-1). Further, sell time clock A (306-1) indicates that a portion of asset A (311-1) was sold during the fifth period (302-5). As a result, a list of trades for asset A (311-1) may include buy clock time A (304-1), buy clock time B (304-2), buy clock time C (304-3), sell clock time A (306-1), and sell clock time B (306-2). Although not illustrated in the diagram (300), each of the buy clock times (304) and sell clock times (306) may specify how much of the assets (311) were bought or sold.

A method of trade attribution matching will now be described with reference to FIG. 3. A sale of asset A (311-1) as characterized by sell time clock A (306-1) is matched with a buy of asset A (311-1) as characterized by buy time clock C (304-3). If the sale of asset A (311-1) still remains as described by the equations associated with FIG. 2, the sale of asset A (311-1) as characterized by sell time clock A (306-1) is matched with a buy of asset A (311-1) as characterized by buy time clock B (304-2). Further, if the sale of asset A (311-1) still remains as described by the equations associated with FIG. 2, the sale of asset A (311-1) as characterized by sell time clock A (306-1) is matched with a buy of asset A (311-1) as characterized by buy time clock A (304-1).

The sale of asset A (311-1) as characterized by sell time clock B (306-2) is matched with an unmatched buy of asset A (311-1) as characterized by buy time clock C (304-3). If the sale of asset A (311-1) still remains as described by the equations associated with FIG. 2, the sale of asset A (311-1) as characterized by sell time clock B (306-2) is matched with an unmatched buy of asset A (311-1) as characterized by buy time clock B (304-2). If the sale of asset A (311-1) still remains as described by the equations associated with FIG. 2, the sale of asset A (311-1) as characterized by sell time clock B (306-2) is matched with an unmatched buy of asset A (311-1) as characterized by buy time clock A (304-1). As a result, a sale of an asset is matched to a prior buy of the asset using the LIFO method.

Similarly, the trade attribution matching may be applied to asset B (311-2) and asset C (311-3). The trade attribution matching may be applied according to the buy clock times and sell clock times associated with asset B (311-2) and asset C (311-3). As a result, a bottom-up approach is utilized whereby the rebalancing trading profit contribution is calculated at an asset level and aggregated to a portfolio level.

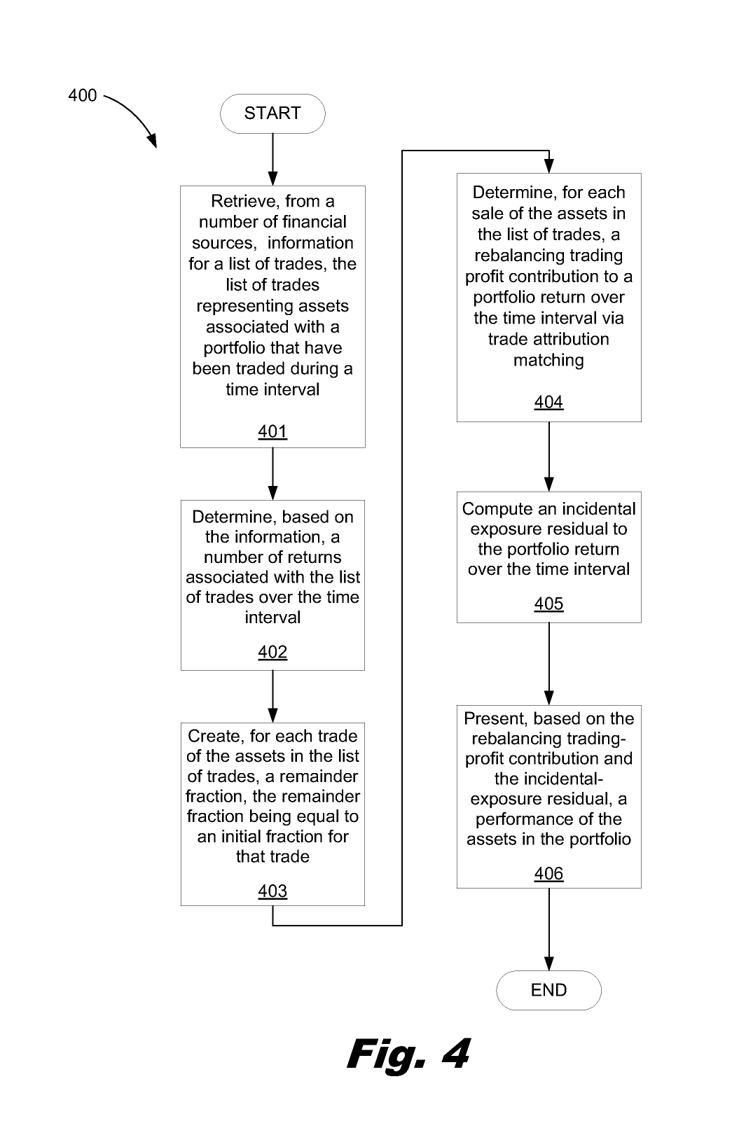

FIG. 4 is a flowchart of an example of a method for analyzing a performance of at least one asset in a portfolio, according to one example of principles described herein. The method (400) may be executed by the system (100) of FIG. 1. The method (400) may be executed by other systems such as system 200, system 500, or system 600. In this example, the method (400) includes retrieving (401), from a number of financial sources, information for a list of trades, the list of trades representing assets associated with a portfolio that have been traded during a time interval, determining (402), based on the information, a number of returns associated with the list of trades over the time interval, creating (403), for each trade of the assets in the list of trades, a remainder fraction, the remainder fraction being equal to an initial fraction for that trade, determining (404), for each sale of the assets in the list of trades, a rebalancing trading profit contribution to a portfolio return over the time interval via trade attribution matching, computing (405) an incidental exposure residual to the portfolio return over the time interval, and presenting (406), based on the rebalancing trading profit contribution and the incidental exposure residual, a performance of the assets in the portfolio.

As mentioned above, the method (400) includes retrieving (401), from a number of financial sources, information for a list of trades, the list of trades representing assets associated with a portfolio that have been traded during a time interval. To determine the list of trades, the method (400) may determine which assets of a portfolio were traded during a time interval. A list of trades for the assets traded during the time interval is then determined. For example, if a portfolio includes asset A, asset B, and asset C, then the method (400) may determine if asset A, asset B, or asset C were traded during the time interval. If the method (400) determines that asset A and asset C were traded during the time interval, a list of trades for asset A and asset C may be retrieved. The list of trades may include buy clock times and sell clock times as described above. Further, the information may a time interval for which the performance of the assets in a portfolio is to be analyzed. The time interval may be in terms of seconds, minutes, hours, days, weeks, months, years, other time intervals, or combinations thereof. The time interval may be based on events in time, such as when the method (400) or a user accesses the information, when an asset is traded, when an asset in a portfolio reaches a monetary threshold, other events in time, or combinations thereof

As mentioned above, the method (400) includes determining (402), based on the information, a number of returns associated with the list of trades over the time interval. The number of returns may include an asset return, a portfolio return, and a benchmark return, other returns or combinations thereof. The number of returns may be determined when the method (400) retrieves the information. The number of returns may be determined at an end of the time interval. For example, if the time interval starts at time Y and ends at time Z, the number of returns may be determined at time Z for asset A and asset C.

As mentioned above, the method (400) includes creating (403), for each trade of the assets in the list of trades, a remainder fraction, the remainder fraction being equal to an initial fraction for that trade. An initial fraction may be determined for each trade of the asset and the remainder initial fraction may be set equal to the initial fraction. For example, a remainder fraction, such as a sell remainder fraction or a buy remainder fraction, for the first trade of asset A may be set equal to an initial fraction for that trade.

As mentioned above, the method (400) includes determining (404), for each sale of the assets in the list of trades, a rebalancing trading profit contribution to a portfolio return over the time interval via trade attribution matching. The rebalancing trading profit contribution may be in terms of monetary value, a percentage, a fraction, other terms, or combinations thereof.

As mentioned above, the method (400) includes computing (405) an incidental exposure residual to the portfolio return over the time interval. The incidental exposure residual may be stated in terms of monetary value, a percentage, a fraction, other terms, or combinations thereof

As mentioned above, the method (400) includes presenting (406), based on the rebalancing trading profit contribution and the incidental exposure residual, a performance of the assets in the portfolio. The performance may be displayed via a display of a display device. The performance may be presented via a display of a display device as a sector, country, which assets performed the best over the time interval, or which assets performed the worst over the time interval.

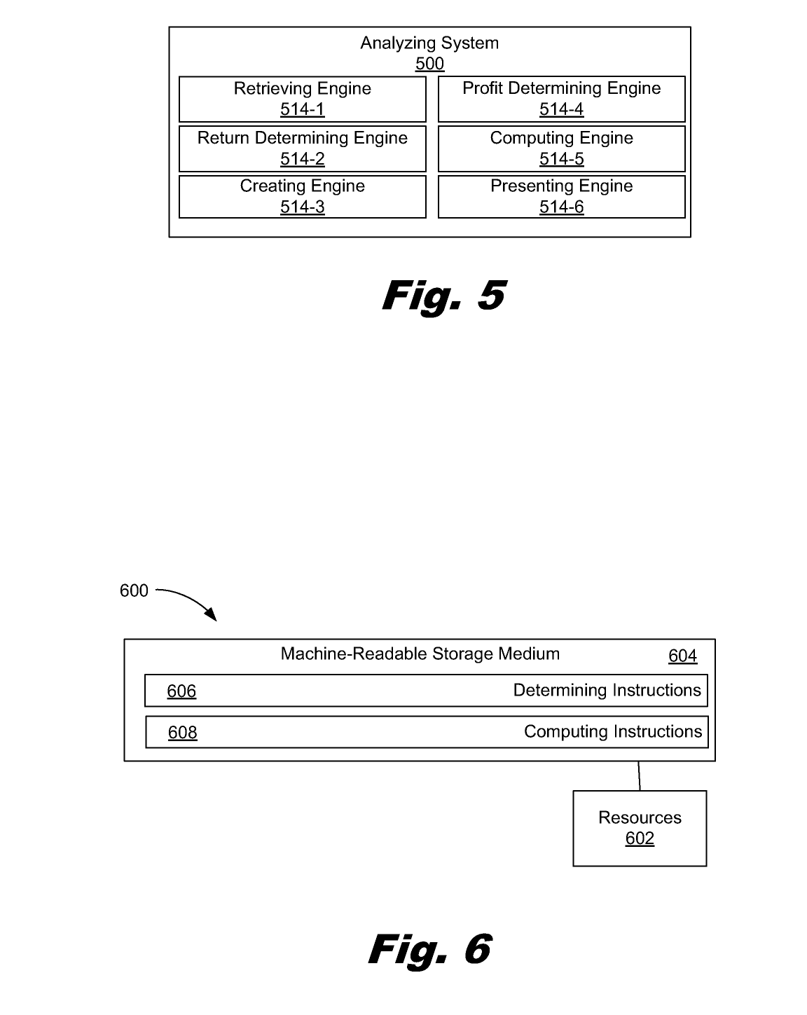

FIG. 5 is a diagram of an analyzing system, according to one example of principles described herein. The analyzing system (500) includes a retrieving engine (514-1), a return determining engine (514-2), a creating engine (514-3), a profit determining engine (514-4), a computing engine (514-5), and a presenting engine (514-6). The engines (514) refer to a combination of hardware and program instructions to perform a designated function. Alternatively, the engines (514) may be implemented in the form of electronic circuitry (e.g., hardware). Each of the engines (514) may include a processor and memory. Alternatively, one processor may execute the designated function of each of the engines (514). The program instructions are stored in the memory and cause the processor to execute the designated function of the engine.

The retrieving engine (514-1) retrieves, from a number of financial sources, information for a list of trades, the list of trades representing assets associated with a portfolio that have been traded during a time interval. The retrieving engine (514-1) may retrieve information for one asset associated with one list of trades. The retrieving engine (514-1) may retrieve information for several assets associated with several lists of trades.

The return determining engine (514-2) determines, based on the information, a number of returns associated with the list of trades over the time interval. The return determining engine (514-2) determines, based on the information, a number of returns associated with several lists of trades over several time intervals for several assets.

The creating engine (514-3) creates, for each trade of the assets in the list of trades, a remainder fraction, the remainder fraction being equal to an initial fraction for that trade. The creating engine (514-3) creates, for each trade of the assets in the list of trades, a sell remainder fraction or a buy remainder fraction, the sell remainder fraction or the buy remainder fraction on being equal to an initial fraction for that trade.

The profit determining engine (514-4) determines, for each sale of the assets in the list of trades, a rebalancing trading profit contribution to a portfolio return over the time interval via trade attribution matching. The profit determining engine (514-4) determines several rebalancing trading profit contributions to several portfolio returns over several time intervals via trade attribution matching.

The computing engine (514-5) may compute an incidental exposure residual to the portfolio return over the time interval. The computing engine (514-5) may compute an incidental exposure residual to the portfolio return over several time intervals.

The presenting engine (514-6) presents, based on the rebalancing trading profit contribution and the incidental exposure residual, a performance of the assets in the portfolio. The presenting engine (514-6) presents, based on the rebalancing trading profit contribution and the incidental exposure residual, several performances of the assets in the portfolio.

FIG. 6 is a diagram of an analyzing system, according to one example of principles described herein. In this example, the analyzing system (600) includes resource(s) (602) that are in communication with a machine-readable storage medium (604). Resource(s) (602) may include one processor. In another example, the resource(s) (602) may further include at least one processor and other resources used to process instructions. The machine-readable storage medium (604) represents generally any memory capable of storing data such as instructions or data structures used by the analyzing system (600). The instructions shown stored in the machine-readable storage medium (604) include determining instructions (606) and computing instructions (608).

The machine-readable storage medium (604) contains computer readable program code to cause tasks to be executed by the resource(s) (602). The machine-readable storage medium (604) may be tangible and/or physical storage medium. The machine-readable storage medium (604) may be any appropriate storage medium that is not a transmission storage medium. A non-exhaustive list of machine-readable storage medium types includes non-volatile memory, volatile memory, random access memory, write only memory, flash memory, electrically erasable program read only memory, or types of memory, or combinations thereof.

The determining instructions (606) represents instructions that, when executed, cause the resource(s) (602) to determine, for each sale of assets in a list of trades, a rebalancing trading profit contribution to a portfolio return over a time interval via trade attribution matching. The computing instructions (608) represents instructions that, when executed, cause the resource(s) (602) to compute an incidental exposure residual to the portfolio return over the time interval.

Although not illustrated, the instructions stored in the machine-readable storage medium (604) may further include retrieve instructions, return determining instructions, creating instructions, and presenting instructions. The retrieve instructions represents instructions that, when executed, cause the resource(s) (602) to retrieve, from a number of financial sources, information for the list of trades, the list of trades representing the assets associated with a portfolio that have been traded during a time interval.

The return determining instructions represents instructions that, when executed, cause the resource(s) (602) to determine, based on the information, a number of returns associated with the list of trades over the time interval. The creating instructions represents instructions that, when executed, cause the resource(s) (602) to create, for each trade of the assets in the list of trades, a remainder fraction, the remainder fraction being equal to an initial fraction for that trade. The presenting instructions represents instructions that, when executed, cause the resource(s) (602) to present, based on the rebalancing trading profit contribution and the incidental exposure residual, a performance of the assets in the portfolio.

Further, the machine-readable storage medium (604) may be part of an installation package. In response to installing the installation package, the instructions of the machine-readable storage medium (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the resource(s) (602) and the machine-readable storage medium (604) are located within the same physical component, such as a server, or a network component. The machine-readable storage medium (604) may be part of the physical component's main memory, caches, registers, non-volatile memory, or elsewhere in the physical component's memory hierarchy. Alternatively, the machine-readable storage medium (604) may be in communication with the resource(s) (602) over a network. Further, the data structures, such as the libraries, may be accessed from a remote location over a network connection while the programmed instructions are located locally. Thus, the analyzing system (600) may be implemented on a user device, a display device, on a server, on a collection of servers, or combinations thereof.

The analyzing system (600) of FIG. 6 may be part of a general purpose computer. However, in alternative examples, the analyzing system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1. A method for analyzing a performance of at least one asset in a portfolio, the method comprising:
retrieving, from a number of financial sources, information for a list of trades, the list of trades representing assets associated with a portfolio that have been traded during a time interval;
determining, based on the information, a number of returns associated with the list of trades over the time interval;
creating, for each trade of the assets in the list of trades, a remainder fraction, the remainder fraction being equal to an initial fraction for that trade;
determining, for each sale of the assets in the list of trades, a rebalancing trading profit contribution to a portfolio return over the time interval via trade attribution matching;
computing an incidental exposure residual to the portfolio return over the time interval; and
presenting, based on the rebalancing trading profit contribution and the incidental exposure residual, a performance of the assets in the portfolio.

2. The method of claim 1, in which each of the assets in the portfolio are characterized by a time clock, a side of each trade, and the initial fraction.

3. The method of claim 1, in which the number of returns associated with the list of trades over the time interval comprises an asset return, a portfolio return, and a benchmark return.

4. The method of claim 1, in which determining, for each sale of the assets in the list of trades, the rebalancing trading profit contribution to the portfolio return over the time interval via the trade attribution matching comprises:
ordering each sale of the assets in the list of trades sequentially based on a clock time;
determining if a sell remainder fraction for one of the assets is zero;
identifying a buy of one of the assets with a buy clock time prior to a sell clock time for which a buy remainder fraction is positive;
computing a discount factor;
computing a buy discount remainder fraction of a portfolio weight bought discounted at the sell clock time;
computing a matched weight;
reducing the buy remainder faction by a quantity of the matched weight divided by the discount factor;
reducing the sell remainder fraction by the matched weight;
computing a relative return difference;
computing a contribution of a trade profit due to a trading of the assets; and
accumulating, based on the sell clock time, the contribution of the trade profit to an overall sum, the overall sum representing the rebalancing trading profit contribution to the portfolio return over the time interval.

5. The method of claim 1, in which an aggregate trade of the assets replaces a trade of the assets when more than one trade of the assets occurs within an accuracy of a time clock.

6. The method of claim 1, in which the assets are modified based on corporate actions, the corporate actions comprising changing an identifier of at least one of the assets, creating a split or a reverse split of at least one of the assets, a demerging of at least one of the assets, a merging of at least one of the assets, or combinations thereof.

7. The method of claim 1, in which the assets of the portfolio created at a discrete instant in time are pretreated.

8. The method of claim 1, in which a collection of the assets are further pretreated when the collection of the assets is implemented at a specific clock time for a purpose of inserting or extracting cash liquidity to or from the portfolio.

9. A system for analyzing a performance of at least one asset in a portfolio, the system comprising:
a processor;
a memory, comprising computer program code, communicatively coupled to the processor;
a network interface for communicating data via a computer network;
a display device;
wherein, the computer program code comprising;
a creating engine to create, for each trade of assets in a list of trades, a remainder fraction, the remainder fraction being equal to an initial fraction for that trade;
a profit determining engine to determine, for each sale of the assets in the list of trades, a rebalancing trading profit contribution to a portfolio return over a time interval via trade attribution matching;
a computing engine to compute an incidental exposure residual to the portfolio return over the time interval; and
a presenting engine to present using the display device, based on the rebalancing trading profit contribution and the incidental exposure residual, a performance of the assets in a portfolio.

10. The system of claim 9, further comprising a retrieving engine to retrieve, from a number of financial sources, information for the list of trades, the list of trades representing the assets associated with the portfolio that have been traded during the time interval.

11. The system of claim 9, further comprising a return determining engine to determine, based on information, a number of returns associated with the list of trades over the time interval.

12. The system of claim 9, in which the profit determining engine determines, for each sale of the assets in the list of trades, the rebalancing trading profit contribution to the portfolio return over the time interval via the trade attribution matching by:
ordering each sale of the assets in the list of trades sequentially based on a clock time;
determining if a sell remainder fraction for one of the assets is zero;
identifying a buy of one of the assets with a buy clock time prior to a sell clock time for which a buy remainder fraction is positive;
computing a discount factor; and
computing a buy discount remainder fraction of a portfolio weight bought discounted at the sell clock time.

13. The system of claim 12, in which the profit determining engine further determines, for each sale of the assets in the list of trades, the rebalancing trading profit contribution to the portfolio return over the time interval via the trade attribution matching by:
computing a matched weight;
reducing the buy remainder faction by a quantity of the matched weight divided by the discount factor;
reducing the sell remainder fraction by the matched weight;
computing a relative return difference;
computing a contribution of a trade profit due to a trading of the assets; and
accumulating, based on the sell clock time, the contribution of the trade profit to an overall sum, the overall sum representing the rebalancing trading profit contribution to the portfolio return over the time interval.

14. A machine-readable storage medium encoded with instructions for analyzing a performance of at least one asset in a portfolio, the instructions executable by a processor of a system to cause the system to:
determine, for each sale of assets in a list of trades, a rebalancing trading profit contribution to a portfolio return over a time interval via trade attribution matching; and
compute an incidental exposure residual to the portfolio return over the time interval.

15. The product of claim 14, further comprising instructions that, when executed, cause the processor to:
retrieve, from a number of financial sources, information for the list of trades, the list of trades representing the assets associated with a portfolio that have been traded during a time interval; and
determine, based on the information, a number of returns associated with the list of trades over the time interval.

16. The product of claim 14, further comprising instructions that, when executed, cause the processor to:
create, for each trade of the assets in the list of trades, a remainder fraction, the remainder fraction being equal to an initial fraction for that trade; and
present, based on the rebalancing trading profit contribution and the incidental exposure residual, a performance of the assets in the portfolio.

17. The product of claim 14, in which the trade attribution matching comprises:
ordering each sale of the assets in the list of trades sequentially based on a clock time;
determining if a sell remainder fraction for one of the assets is zero;
identifying a buy of one of the assets with a buy clock time prior to a sell clock time for which a buy remainder fraction is positive;
computing a discount factor;
computing a buy discount remainder fraction of a portfolio weight bought discounted at the sell clock time;
computing a matched weight;
reducing the buy remainder faction by a quantity of the matched weight divided by the discount factor;
reducing the sell remainder fraction by the matched weight;
computing a relative return difference;
computing a contribution of a trade profit due to a trading of the assets; and
accumulating, based on the sell clock time, the contribution of the trade profit to an overall sum, the overall sum representing the rebalancing trading profit contribution to the portfolio return over the time interval.

18. The product of claim 14, in which a collection of the assets are pretreated when the collection of the assets is implemented at a specific clock time for a purpose of inserting or extracting cash liquidity to or from a portfolio.

19. The product of claim 14, in which the assets are modified based on corporate actions, the corporate actions comprising changing an identifier of at least one of the assets, creating a split or a reverse split of at least one of the assets, a demerging of at least one of the assets, a merging of at least one of the assets, or combinations thereof.

20. The product of claim 14, in which a number of returns associated with the list of trades over the time interval comprises an asset return, a portfolio return, and a benchmark return.
